(19) United States
(12) Patent Application Publication
(10) Pub. No.: US 2025/0274171 A1
(43) Pub. Date: Aug. 28, 2025

(54) SUBSPACE PRECODING

(71) Applicant: Samsung Electronics Co., Ltd., Suwon-si (KR)

(72) Inventors: R A Nadisanka Perera Rupasinghe, McKinney, TX (US); Yang Li, Plano, TX (US); Rajesh Kumar Mishra, Plano, TX (US)

(21) Appl. No.: 19/050,020

(22) Filed: Feb. 10, 2025

Related U.S. Application Data
(60) Provisional application No. 63/557,350, filed on Feb. 23, 2024.

(51) Int. Cl. H04B 7/0456; H04B 17/309

(52) U.S. Cl. CPC H04B 7/0456; H04B 17/346

(57) ABSTRACT

A base station (BS) includes a transceiver. The transceiver is configured to receive, from k user equipments (UEs), a sounding reference signal (SRS), wherein k is an integer greater than or equal to 1. The BS also includes a processor operatively coupled to the transceiver. The processor is configured to denoise the SRS received from the k UEs, derive, based on the denoised SRS from the k UEs, a common precoder for a plurality of resource blocks (RBs), as a wideband precoder, and provide a wideband multi-user precoding scheme for the k UEs based on the wideband precoder.

### CROSS-REFERENCE TO RELATED APPLICATION(S) AND CLAIM OF PRIORITY

This application claims priority under 35 U.S.C. § 119 (e) to U.S. Provisional Patent Application No. 63/557,350 filed on Feb. 23, 2024. The above-identified provisional patent application is hereby incorporated by reference in its entirety.

### TECHNICAL FIELD

This disclosure relates generally to wireless networks. More specifically, this disclosure relates to subspace precoding.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for subspace precoding.

In one embodiment, a base station (BS) is provided. The BS includes a transceiver. The transceiver is configured to receive, from k user equipments (UEs), a sounding reference signal (SRS), wherein k is an integer greater than or equal to 1. The BS also includes a processor operatively coupled to the transceiver. The processor is configured to denoise the SRS received from the k UEs, derive, based on the denoised SRS from the k UEs, a common precoder for a plurality of resource blocks (RBs), as a wideband precoder, and provide a wideband multi-user precoding scheme for the k UEs based on the wideband precoder.

In another embodiment, a method of operating a BS is provided. The method includes receiving, from k UEs, an SRS, wherein k is an integer greater than or equal to 1, and denoising the SRS received from the k UEs. The method also includes deriving, based on the denoised SRS from the k UEs, a common precoder for a plurality of RBs, as a wideband precoder, and providing a wideband multi-user precoding scheme for the k UEs based on the wideband precoder.

In yet another embodiment, a non-transitory computer readable medium embodying a computer program is provided. The computer program includes program code that, when executed by a processor of a device, causes the device to receive, from k UEs, an SRS, wherein k is an integer greater than or equal to 1, and denoise the SRS received from the k UEs. The computer program also includes program code that, when executed by a processor of the device, causes the device to derive, based on the denoised SRS from the k UEs, a common precoder for a plurality of RBs, as a wideband precoder, and provide a wideband multi-user precoding scheme for the k UEs based on the wideband precoder.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

The following documents and standards descriptions are hereby incorporated by reference into the present disclosure as if fully set forth herein:
[1] B. Ghojogh, F Karray, and M. Crowley, ‘Eigenvalue and Generalized Eigenvalue Problems: Tutorial’, arXiv, May 2022.
[2] Andre Tkacenko, P. P. Vaidyanathan, and Truong Q. Nguyen, ‘On the Eigenfilter Design Method and Its Applications: A Tutorial’, IEEE Trans. Analog & Digital Sig. Proc., September 2003.
[3] A. Eremenko, “Simultaneous diagonalization of two quadratic forms and a generalized eigenvalue problem”, Perdue University, April 2020.
[4] 3GPP TS 36.211 v16.4.0, “E-UTRA, Physical channels and modulation.”
[5] 3GPP TS 36.212 v16.4.0, “E-UTRA, Multiplexing and Channel coding.”
[6] 3GPP TS 36.213 v16.4.0, “E-UTRA, Physical Layer Procedures.”
[7] 3GPP TS 36.321 v16.3.0, “E-UTRA, Medium Access Control (MAC) protocol specification.”
[8] 3GPP TS 36.331 v16.3.0, “E-UTRA, Radio Resource Control (RRC) Protocol Specification.” [9]
[9] 3GPP TS 38.211 v16.4.0, “NR, Physical channels and modulation.”
[10] 3GPP TS 38.212 v16.4.0, “NR, Multiplexing and Channel coding.”
[11] 3GPP TS 38.213 v16.4.0, “NR, Physical Layer Procedures for Control.”
[12] 3GPP TS 38.214 v16.4.0, “NR, Physical Layer Procedures for Data.”
[13] 3GPP TS 38.215 v16.4.0, “NR, Physical Layer Measurements.”
[14] 3GPP TS 38.321 v16.3.0, “NR, Medium Access Control (MAC) protocol specification.”
[15] 3GPP TS 38.331 v16.3.1, “NR, Radio Resource Control (RRC) Protocol Specification.”

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example of CSI-RS port mapping according to embodiments of the present disclosure;

FIG. 5 illustrates an example of distributed MIMO according to embodiments of the present disclosure;

FIG. 6 illustrates another example of distributed MIMO according to embodiments of the present disclosure;

FIG. 7 illustrates an example of transmit antenna switching according to embodiments of the present disclosure;

FIG. 8 illustrates an example method for deriving sub-space precoders according to embodiments of the present disclosure;

FIG. 9 illustrates an example of BS reception according to embodiments of this disclosure;

FIG. 10 illustrates an example of precoding mode switching options according to embodiments of the present disclosure;

FIG. 11 illustrates an example method for subspace precoding according to embodiments of the present disclosure; and

FIG. 12 illustrates an example method for dynamic precoding mode switching according to embodiments of the present disclosure.

### DETAILED DESCRIPTION

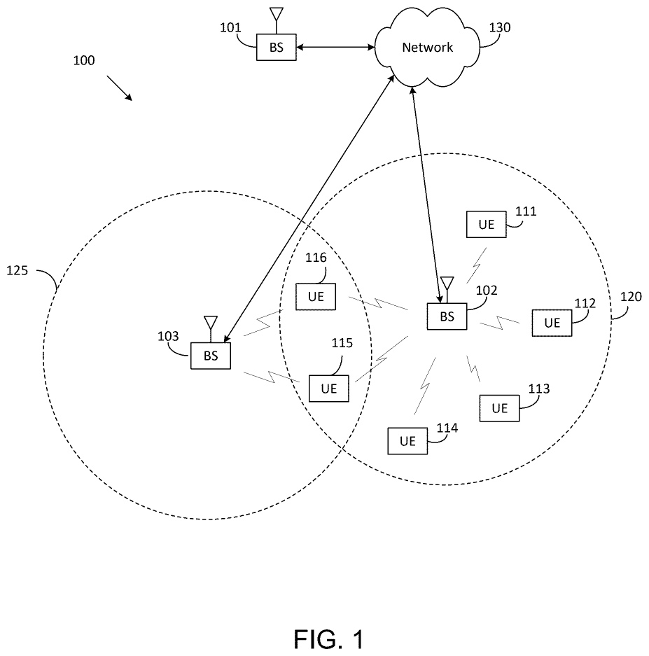

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is implemented in higher frequency (mm Wave) bands, e.g., 28 GHz or 60GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands. Furthermore, various embodiments may apply to operating with other radio access technologies (RATs) and/or standards, such as different releases/generations of 3GPP standards (including beyond 5G, 6G, etc.), IEEE standards (such as 802.16 WiMAX and 802.11 Wi-Fi), and so on.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for subspace precoding. In certain embodiments, one or more of the gNBs 101-103 includes circuitry, programing, or a combination thereof, to support subspace precoding in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

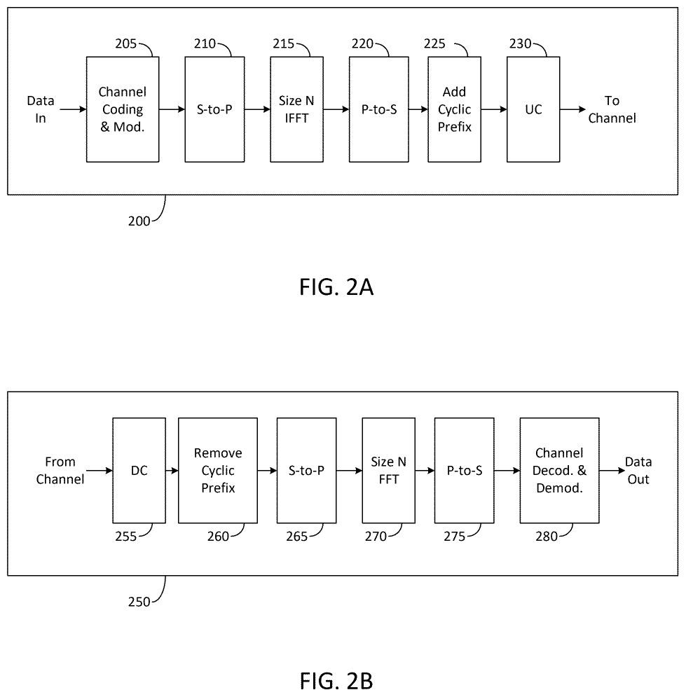

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support subspace precoding as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

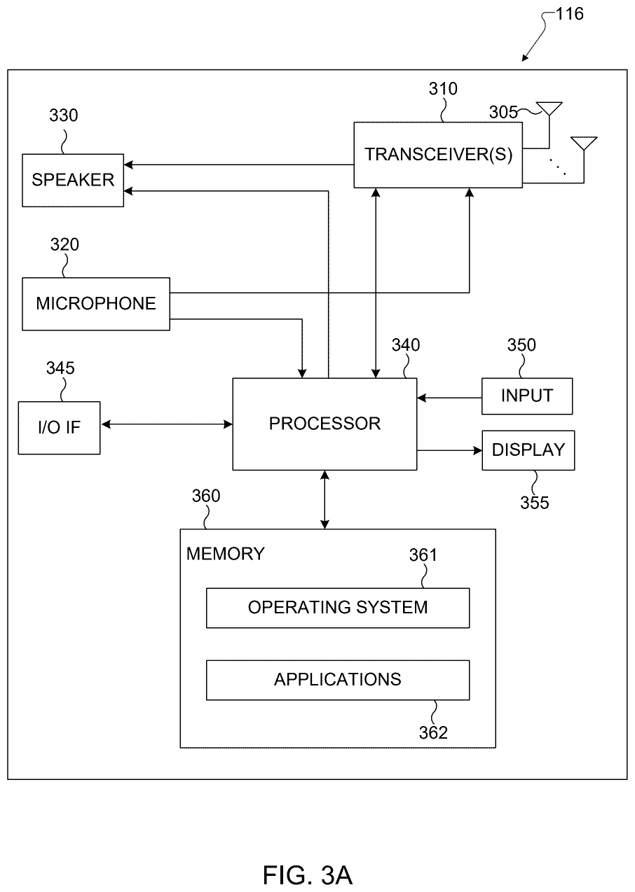

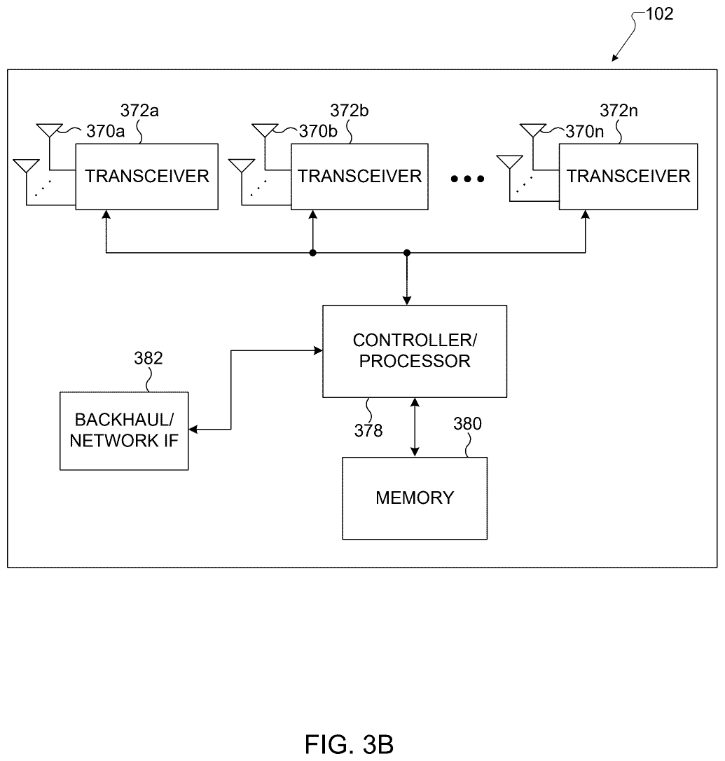

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for subspace precoding as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUS). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support subspace precoding as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

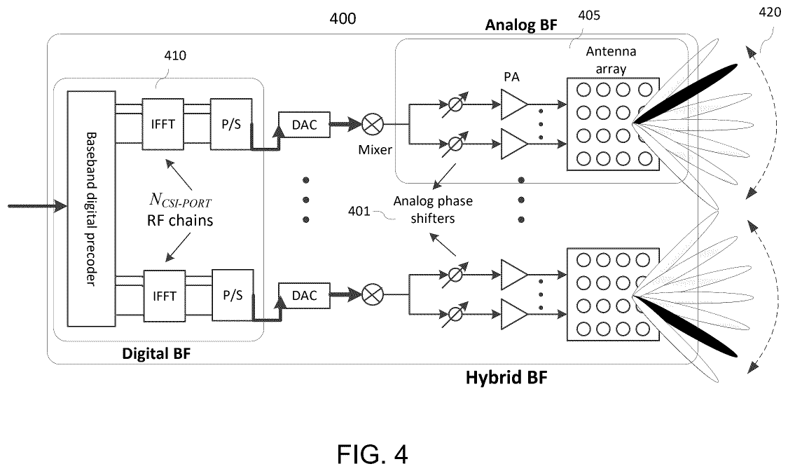

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 4.

FIG. 4 illustrates an example of CSI-RS port mapping 400 according to embodiments of the present disclosure. The embodiment of CSI-RS port mapping of FIG. 4 is for illustration only. Different embodiments of CSI-RS port mapping could be used without departing from the scope of this disclosure.

In the example of FIG. 4, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles (420) by varying the phase shifter bank across symbols or subframes. The number of sub-arrays (equal to the number of RF chains) is the same as the number of CSI-RS ports NCSI-PORT. A digital beamforming unit 410 performs a linear combination across NCSI-PORT analog beams to further increase precoding gain. While analog beams are wideband (hence not frequency-selective), digital precoding can be varied across frequency sub-bands or resource blocks (RBs). Receiver operation can be conceived analogously.

Although FIG. 4 illustrates one example of CSI-RS port mapping 400, various changes may be made to FIG. 4. For example, various changes to the number of beams could be made, the size of the antenna array, etc. according to particular needs.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @100 m distance), larger numbers of and sharper analog beams (hence larger number of radiators in the array) are used to compensate for the additional path loss.

At lower frequency bands such as FR1 or particularly sub-1 GHz band, on the other hand, the number of antenna elements cannot be increased in a given form factor due to large wavelength if a critical distance (>N/2) between two adjacent antenna elements is maintained in deployment scenarios. As an example, for the case of the wavelength size (2) of the center frequency 600 MHz (which is 50 cm), it requires 4 m for uniform-linear-array (ULA) antenna panel of 16 antenna elements with the half-wavelength distance between two adjacent antenna elements. Considering a plurality of antenna elements is mapped to one digital port in practical cases, the required size for antenna panels at gNB to support a large number of antenna ports, e.g., 32 CSI-RS ports, becomes very large in such low frequency bands, and it leads to the difficulty of deploying 2-D antenna arrays within the size of a desired form factor. This can result in a limited number of physical antenna elements and, subsequently CSI-RS ports, that can be supported at a single site and limits the spectral efficiency of such systems.

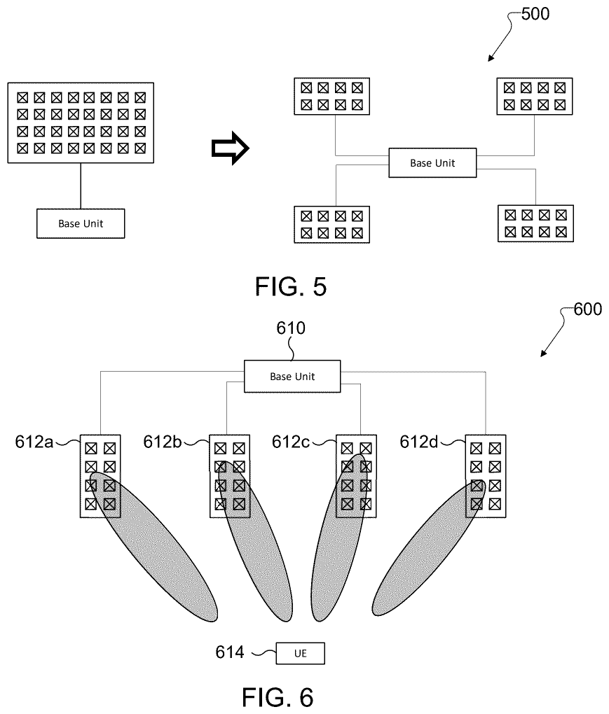

One possible approach to resolve the issue is to form multiple antenna panels (e.g., antenna modules, RRHs) with a small number of antenna ports instead of integrating all of the antenna ports in a single panel (or at a single site) and to distribute the multiple panels in multiple locations/sites (or RRHs), as illustrated in FIG. 5.

FIG. 5 illustrates an example of distributed MIMO 500 according to embodiments of the present disclosure. In the example of FIG. 5, distributed MIMO 500 is formed from multiple antenna panels, such as antenna modules or remote radio heads (RRHs), with a small number of antenna ports instead of integrating all the antenna ports in a single panel or at a single site and distributing the multiple panels in multiple locations/sites or RRHs. The example of FIG. 5 may be implemented by a BS. For example, the example of distributed MIMO 500 may be implemented by one or more BSs such as BS 102. The example of distributed MIMO 500 is for illustration only and other embodiments can be used without departing from the scope of the present disclosure.

The multiple antenna panels at multiple locations can still be connected to a single base unit, and thus the signal transmitted/received via multiple distributed panels can be processed in a centralized manner through the single base unit, as illustrated in FIG. 6. In another embodiment, it is possible that multiple distributed antenna panels are connected to more than one base unit, which communicate with each other and jointly support the single antenna system.

FIG. 6 illustrates another example of distributed MIMO 600 according to embodiments of the present disclosure. In the example of FIG. 6, multiple antenna locations 612a-612d are connected to a single base unit 610. The base unit 610 may process signals transmitted and received via antenna locations 612a-612d in a centralized manner. For example, base unit 610 may process signals transmitted and received to UE 614. The example of FIG. 6 may be implemented by a BS. For example, the distributed MIMO 600 may be implemented by one or more BSs such as BS 102. The example of distributed MIMO 600 is for illustration only and other embodiments can be used without departing from the scope of the present disclosure.

In TDD systems, where the DL and UL channels are considered reciprocal, a base station can calculate DL precoding weights based on the sounding reference signal (SRS) that a UE transmits in the UL. In order to obtain the full MIMO channel, channels at N receive antennas are distinguished and the UE transmits SRS for each of the UE's individual receive antennas.

Although a UE may have N receive antennas, in general, the number of a UE's uplink transmit antennas is smaller. The reasons are, first, UL transmission is more power-limited than DL transmission, and it is more efficient not to increase the number of layers per device in power-limited conditions. Next, adding RF transmit chains to the device may cause several implementation issues such as excessive device power drainage, placement overlaps with cameras and sensors in smart phones, and mobile device radio wave's effect on a human body (a.k.a. specific absorption rate [SAR]).

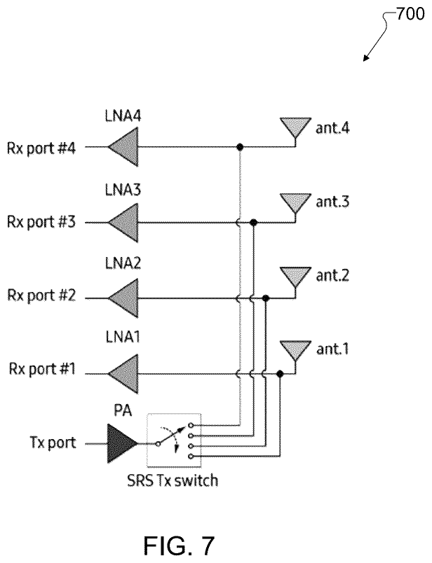

In order to avoid such problems, a single transmit RF chain can be connected to one of the receive antennas through a switch when it transmits SRS, as shown in FIG. 7. This is called ‘SRS transmit antenna switching (TAS)’.

FIG. 7 illustrates an example of TAS 700 according to embodiments of the present disclosure. In the example of FIG. 7, a UE configuration with single transmit and four receive antenna switching (T1R4) is shown. The example of TAS 700 is for illustration only and other embodiments can be used without departing from the scope of the present disclosure.

When using TAS, a UE transmits an individual SRS for each receive antenna and a base station is able to construct directly a (M×N) channel matrix from the received SRS responses. The base station can decide the best beamforming weight to maximize DL capacity without any quantization error as long as the received SRS is high enough in quality.

Another method of DL MIMO is for a UE to report a set of CSI measurement results comprising channel quality indicator (CQI), precoding matrix indicator (PMI), and rank indicator (RI) to the base station. In this method, the UE continuously monitors a set of M port reference signals at every receive antenna and constructs an (N×M) MIMO channel matrix. Out of the given precoding matrix candidates, it selects the best precoding matrix which is best fitted to the MIMO channel and feeds back the corresponding Type-I PMI through the UL.

SRS-based precoding has some advantages over PMI-based precoding. For example, the BS is able to acquire CSI without quantization error. Furthermore, SRS-based precoding is robust to channel frequency selectivity because each resource block's beamforming weight can be calculated independently based on the SRS response.

However, the signal quality of SRS is easily contaminated by UL transmit power shortage at the cell's coverage edge. Because SRS channel response should be estimated individually at M base station antennas, unlike other uplink data/control channels, its receive performance cannot be recovered by antenna combining or error-correction codes. If the UE is located in the cell's coverage edge and the estimated SRS channel response is not accurate enough, the gain of SRS-based precoding is degraded accordingly.

To reap the maximum benefits from 5G NR systems, multi user (MU)-MIMO transmission is used. However, when UL channel quality is not good, most of the gains observed from MU-MIMO transmission diminishes. This is because, single user (SU)/MU precoders derived from noisy SRS are not that good.

In some embodiments, if the UL coverage of a UE is good (e.g., the SRS from the UE has a high signal-to-noise ratio [SNR]), the BS configures the UE to operate in TAS mode (i.e., the UE operates in an SRS based precoder mode). Otherwise, if the UL coverage of a UE is not good (e.g., the SRS from the UE has a low SNR), that UE is served with Type-I PMI. However, Type-I PMI cannot accurately represent UE channel direction and as a result, especially with MU-MIMO transmission, achievable performance is limited.

Various embodiments of the present disclosure provide an SRS-based precoding framework for massive MIMO (mMIMO), where sub-space precoders are derived from noisy SRS. During intermediate UL coverage conditions, the sub-space precoders can provide considerable performance gains over PMI based and TAS based precoding.

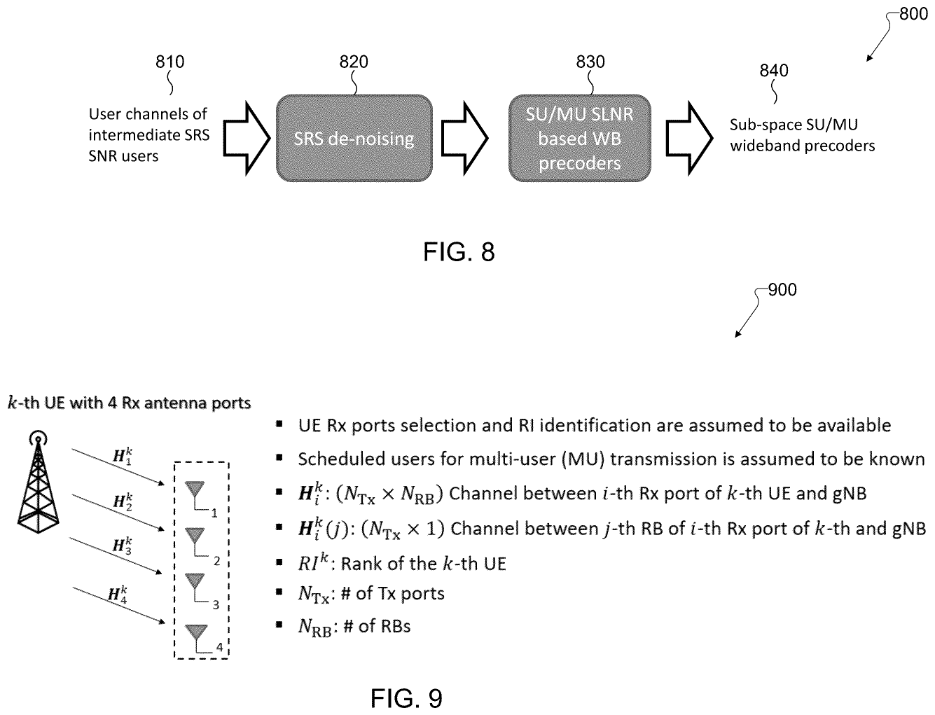

FIG. 8 illustrates an example method 800 for deriving sub-space precoders according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments for deriving sub-space precoders could be used without departing from the scope of this disclosure.

In the example of FIG. 8, method 800 is performed by a BS (such as BS 102 of FIG. 1). The BS is a mMIMO BS for SRS-based precoding, and includes a transceiver configured to receive SRS and PMI on a Physical Uplink Shared Channel (PUSCH) from a UE as shown in FIG. 9.

FIG. 9 illustrates an example of BS reception 900 according to embodiments of this disclosure. The embodiment of BS reception of FIG. 9 is for illustration only. Different embodiments of BS reception could be used without departing from the scope of this disclosure.

In the example of FIG. 9, UE RX port selection and RI identification are assumed to be available, and scheduled users for multi-user transmission is assumed to be known.

The BS comprises N_{Tx} Tx ports and there are NRB number of resource blocks for DL data transmission. Hᵢ^{k} represents the channel (N_{Tx}×N_{RB}) between the i-th Rx port of k-th UE and the BS. Hᵢ^{k}(j), represents the channel (N_{Tx}×1) between the j-th RB of i-th Rx port of k-th UE and the BS.

Although FIG. 9 illustrates one example of BS reception 900, various changes may be made to FIG. 9. For example, various changes to the number of UE RX antenna ports, etc. could be made according to particular needs.

Method 800 begins at step 810. At step 810, a BS (such as BS 102 of FIG. 1) receives UE channels of intermediate SRS SNR UEs (such as UEs 111-116 of FIG. 1) similar as described regarding FIG. 9. The intermediate SRS SNR may be predefined. For example, an SRS SNR above a first threshold, and below a second threshold that is higher than the first threshold may be an intermediate SRS SNR. In some embodiments, the UE channels are RB level SRS channels.

At step 820, the noisy SRS is de-noised. For example, the SRS may be denoised (to some extent) by averaging over frequency. In some embodiments, to denoise the SRS, the BS calculates the spatial co-variance R^{k} of the UE channels from H^{k}, where k∈{1, . . . K} UEs.

At step 830, this de-noised channel information is used to identify a common precoder for all RBs (i.e., a wideband [WB] precoder), which can maximize signal-to-leakage-and-noise ratio (SLNR). The formulation to derive SU/MU SLNR based wide band (WB) precoders may be as described herein.

In some embodiments, the SU/MU precoders are derived according to the following algorithm:
Cholesky decomposition of (R^{k′}+\tilde{σ}²I)= [symbol]
Singular value decomposition of ( [symbol] )^{H}R^{k} [symbol] =ΨΛ^{k}Ψ^{H}
Derive T^{k}= [symbol] Ψ
   where T^{k} is a non-singular matrix, and \tilde{σ} is a regularization factor.

In some embodiments, a subspace precoder for MU, rank=1 transmission may be derived to maximize Signal-to-leakage-and-noise ratio (SLNR) as follows:

Considering MU-MIMO precoding for 2 UEs, the subspace precoder for the k-th UE (k ∈{1, 2}), pᵢ^{k} can then be formulated as an SLNR maximization problem

$$\begin{matrix}{p}_{i}^{k} = arg {max}_{p} \frac{{\sum }_{j = 1}^{{N}_{RB}} {\vert {\{ {H}^{k} ( j ) \}}^{H} p \vert}^{2}}{{\sum }_{j = 1}^{{N}_{RB}} {\vert {\{ {H}_{i}^{{k}^{′}} ( j ) \}}^{H} p \vert}^{2} + {σ}^{2}} \\ s . t . {p}^{H} p = 1 & ( 1 ) \\ = {arg max}_{p} \frac{{p}^{H} ( \frac{1}{{N}_{RB}} {\sum }_{j = 1}^{{N}_{RB}} {H}_{i}^{k} ( j ) {\{ {H}_{i}^{k} ( j ) \}}^{H} ) p}{{p}^{H} ( \frac{1}{{N}_{RB}} {\sum }_{j = 1}^{{N}_{RB}} {H}_{i}^{{k}^{′}} ( j ) {\{ {H}_{i}^{{k}^{′}} ( j ) \}}^{H} ) p + {\tilde{σ}}^{2}} = {arg max}_{p} \frac{{p}^{H} {R}_{i}^{k} p}{{p}^{H} ( {R}_{i}^{{k}^{′}} + {\tilde{σ}}^{2} I ) p} \\ where {R}_{i}^{k} = \frac{1}{{N}_{RB}} {\sum }_{j = 1}^{{N}_{RB}} {H}_{i}^{k} ( j ) {\{ {H}_{i}^{k} ( j ) \}}^{H} , \\ {R}_{i}^{{k}^{′}} = \frac{1}{{N}_{RB}} {\sum }_{j = 1}^{{N}_{RB}} {H}_{i}^{{k}^{′}} ( j ) {\{ {H}_{i}^{{k}^{′}} ( j ) \}}^{H} and \\ {\tilde{σ}}^{2} = \frac{1}{{N}_{RB}} {σ}^{2} . & ( 2 )\end{matrix}$$

Note that, the problem in (2) is a generalized Eigenvalue problem. Note also that, Rᵢ^{k} is a Hermitian matrix and (Rᵢ^{k′}+\tilde{σ}²I) is a Hermitian, positive definite matrix.

Hence, pᵢ^{k} is the dominant eigen vector of matrix, (Rᵢ^{k′}+\tilde{σ}²I)⁻¹Rᵢ^{k}

In some embodiments, a subspace precoder for MU, rank=1 transmission may be derived to minimize the signal leakage as follows:

Considering MU-MIMO precoding for 2 UEs, let the desired energy and leakage energy with subspace precoding at the k-th UE (k ∈{1, 2}) be ε_{i,des}^{k} and ε_{i,leak}^{k}, where

$${ɛ}_{i , des}^{k} = {\sum }_{j = 1}^{{N}_{RB}} {\vert {\{ {H}_{i}^{k} ( j ) \}}^{H} p \vert}^{2} = {p}^{H} {R}_{i}^{k} p$$

$${ɛ}_{i , leak}^{k} = {\sum }_{j = 1}^{{N}_{RB}} {\vert {\{ {H}_{i}^{{k}^{′}} ( j ) \}}^{H} p \vert}^{2} = {p}^{H} {R}_{i}^{{k}^{′}} p$$

$$s . t . {p}^{H} p = 1$$

Given ε_{i,des}^{k} and ε_{i,leak}^{k}, the following minimization problem can be formulated

$${p}_{i}^{k} = {arg min }_{p} {p}^{H} {R}_{i}^{{k}^{′}} p \\ subject to {p}^{H} {R}_{i}^{k} p = 1 \qquad ( 3 )$$

Assuming Rᵢ^{k} is positive definite, it admits Cholesky-like decomposition of the form

Rᵢ^{k}=T^{H}T

Now considering ν=Tp, the optimization problem in equation (3) can be redefined as,

$${ν}_{i}^{k} = {arg min}_{v} {( {T}^{- 1} ν )}^{H} {R}_{i}^{k} {T}^{- 1} v = {arg min}_{v} {{ν}^{H} ( {T}^{- 1} )}^{H} {R}_{i}^{k} {T}^{- 1} ν \\ subject to {ν}^{H} ν = 1 \qquad ( 4 )$$

The solution to equation (4) is the eigen vector corresponding to the smallest eigen value of the matrix (T⁻¹)^{H}Rᵢ^{k′}T⁻¹. Finally, the precoder pᵢ^{k} can be derived as,

$${p}_{i}^{k} = {T}^{- 1} {ν}_{i}^{k}$$

In some embodiments, both solutions discussed above for MU, rank=1 precoding can be easily extended to K UEs MU-MIMO precoding. Regarding the SLNR maximization approach, given the generalized Rayleigh quotient

$$\frac{{p}^{H} {R}_{i}^{k} p}{{p}^{H} ( {\sum }_{{k}^{′} \neq k}^{K} {R}_{i}^{{k}^{′}} + {\tilde{σ}}^{2} I ) p} ,$$

pᵢ^{k} can be solved for similar to equation (2) and hence, pᵢ^{k} is the dominant eigen vector of matrix, (Σ_{k′≠k}^{K}Rᵢ^{k′}+\tilde{σ}²I)⁻¹Rᵢ^{k}.

Note that, in some embodiments, \tilde{σ}² is a regularization factor. In other embodiments, \tilde{σ}² can be related to noise variance as well.

In some embodiments, a subspace precoder for SU, rank>1 transmission may be derived to maximize SLNR as follows:

Let the subspace precoder which maximizes total gain across all RBs at the k-th UE be P^{k} (N_{Tx}×RI^{k}), where RI^{K} is the identified rank for the k-th UE.

$$\begin{matrix}{P}^{k} ( {N}_{Tx} \times {RI}^{k} ) = {arg max}_{P} {\sum }_{j = 1}^{{N}_{RB}} Tr \{ {P}^{H} {H}^{k} ( j ) {( {H}^{k} ( j ) )}^{H} P \} \\ = {arg max}_{P} Tr \{ \frac{1}{{N}_{RB}} {\sum }_{j = 1}^{{N}_{RB}} {P}^{H} {H}^{k} ( j ) {( {H}^{k} ( j ) )}^{H} P \} \\ = {arg max}_{P} Tr \{ {P}^{H} {R}^{k} P \}\end{matrix} \\ s . t . {P}^{H} {R}^{k} P = {D}^{k} ( diagonal matrix ) \\ Tr \{ {P}^{H} P \} = {RI}^{k} \\ where , \\ {R}^{k} = \frac{1}{{N}_{RB}} {\sum }_{j = 1}^{{N}_{RB}} {H}^{k} ( j ) {( {H}^{k} ( j ) )}^{H} and \\ {H}^{k} ( j ) ( {N}_{Tx} \times {RI}^{k} ) \qquad ( 5 )$$

is the channel matrix of j-th RB, across RI^{k} UE ports of k-th UE.

The solution to the optimization problem in equation (5), p^{k} is the precoding matrix comprising RI^{k} number of eigen vectors from R^{k}.

In some embodiments, a subspace precoder for MU, rank>1 transmission may be derived to maximize SLNR as follows:

Considering MU-MIMO precoding for 2 UEs, the subspace precoder for the k-th UE (k=1, 2), p^{k} can be formulated as an SLNR maximization problem as follows:

$$\begin{matrix}{P}^{k} ( {N}_{Tx} \times {RI}^{k} ) = {arg max}_{P} \frac{{\sum }_{j = 1}^{{N}_{RB}} \frac{1}{{N}_{RB}} Tr \{ {P}^{H} {H}^{k} ( j ) {( {H}^{k} ( j ) )}^{H} P \}}{\begin{matrix}{\sum }_{j = 1}^{{N}_{RB}} \frac{1}{{N}_{RB}} Tr \{ {P}^{H} {H}^{{k}^{′}} ( j ) {( {H}^{{k}^{′}} ( j ) )}^{H} P \} + \\ \frac{1}{{N}_{RB}} {σ}^{2} {RI}^{k}\end{matrix}} \\ = {arg max}_{P} \frac{Tr \{ {P}^{H} {R}^{k} P \}}{Tr \{ {P}^{H} ( {R}^{{k}^{′}} + {\tilde{σ}}^{2} I ) P \}}\end{matrix} \\ s . t . {P}^{H} {R}^{k} P = {D}^{k} ( diagonal matrix ) \\ Tr \{ {P}^{H} P \} = {RI}^{k} \\ Where {R}^{k} = \frac{1}{{N}_{RB}} {\sum }_{j = 1}^{{N}_{RB}} {H}^{k} ( j ) {( {H}^{k} ( j ) )}^{H} , \\ {R}_{i}^{{k}^{′}} = \frac{1}{{N}_{RB}} {\sum }_{j = 1}^{{N}_{RB}} {H}_{i}^{{k}^{′}} ( j ) {\{ {H}_{i}^{{k}^{′}} ( j ) \}}^{H} and \\ {\tilde{σ}}^{2} = \frac{1}{{N}_{RB}} {σ}^{2} {RI}^{k} . \qquad ( 6 )$$

Further, H^{k′} (j) (N_{Tx}×RI^{k′}) is the channel matrix of j-th RB across RI^{k′}UE ports of k-th UE whereas H^{k}(j) (N_{Tx}×RI^{k}) is the channel matrix of j-th RB across RI^{k} UE ports of k-th UE.

The solution to equation (6), can be posed as a generalized eigenvalue problem as follows:

Since, R^{k} is Hermitian and (R^{k′}+σ²I) is Hermitian, positive definite, by generalized eigenvalue decomposition, there exists a non-singular matrix T^{k} such that

$${( {T}^{k} )}^{H} {R}^{k} {T}^{k} = {Λ}^{k} \\ {( {T}^{k} )}^{H} ( {R}^{{k}^{′}} + {σ}^{2} I ) {T}^{k} = I$$

where T^{k} can be derived as follows:
The Cholesky decomposition of (R^{k′}°σ²I)

$$( {R}^{{k}^{′}} + {σ}^{2} I ) = {Υ}^{H} Υ$$

Subsequently, from the eigen decomposition of the symmetric matrix, ( [symbol] )^{H}R^{k}

[symbol]

$${( {Υ}^{- 1} )}^{H} {R}^{k} {Υ}^{- 1} = {ΨΛ}^{k} {Ψ}^{H}$$

$${{Ψ}^{H} ( {Υ}^{- 1} )}^{H} {R}^{k} {Υ}^{- 1} Ψ = {Λ}^{k}$$

### Hence,

$${T}^{k} = {Υ}^{- 1} Ψ$$

Assuming entries in Λ^{k} are ordered in ascending order, the first RI^{k} columns of T^{k} maximizes equation (6).

In some embodiments, the solution discussed above for MU, rank>1 precoding can be easily extended to K UEs MU-MIMO precoding. Regarding the SLNR maximization approach, given the generalized Rayleigh quotient,

$$\frac{Tr \{ {P}^{H} {R}^{k} P \}}{Tr \{ {p}^{H} ( {\sum }_{k = {k}^{′}}^{K} {R}_{i}^{{k}^{′}} + {\tilde{σ}}^{2} I ) p \}} ,$$

P^{k} can be solved similar to equation (6), discussed above.

In some embodiments, subspace precoders for SU multi rank, MU single rank can be derived from MU multi rank precoder generation.

At step 840, the BS provides the subspace SU/MU wideband precoders to the UEs.

Although FIG. 8 illustrates one example method 800 for deriving sub-space precoders, various changes may be made to FIG. 8. For example, while shown as a series of steps, various steps in FIG. 8 could overlap, occur in parallel, occur in a different order, occur any number of times, be omitted, or replaced by other steps.

As described above, in some embodiments, if the UL coverage of a UE is good (e.g., the SRS from the UE has a high signal-to-noise ratio [SNR]), the BS configures the UE to operate in TAS mode (i.e., the UE operates in an SRS based precoder mode). Otherwise, if the UL coverage of a UE is not good (e.g., the SRS from the UE has a low SNR), that UE is served with Type-I PMI. However, Type-I PMI cannot accurately represent UE channel direction and as a result, especially with multi-user MIMO transmission, achievable performance is limited. In these embodiments, the BS may configure the UE to switch between the TAS mode and the PMI mode as the UE's coverage changes over time (e.g., due to UE mobility, reduced interference, etc.).

Under intermediate UL coverage, subspace precoding can bring better gains than resource block/resource block group level precoding using SRS or PMI based precoding. The intermediate SRS SNR may be predefined. For example, an SRS SNR above a first threshold, and below a second threshold that is higher than the first threshold may be an intermediate SRS SNR.

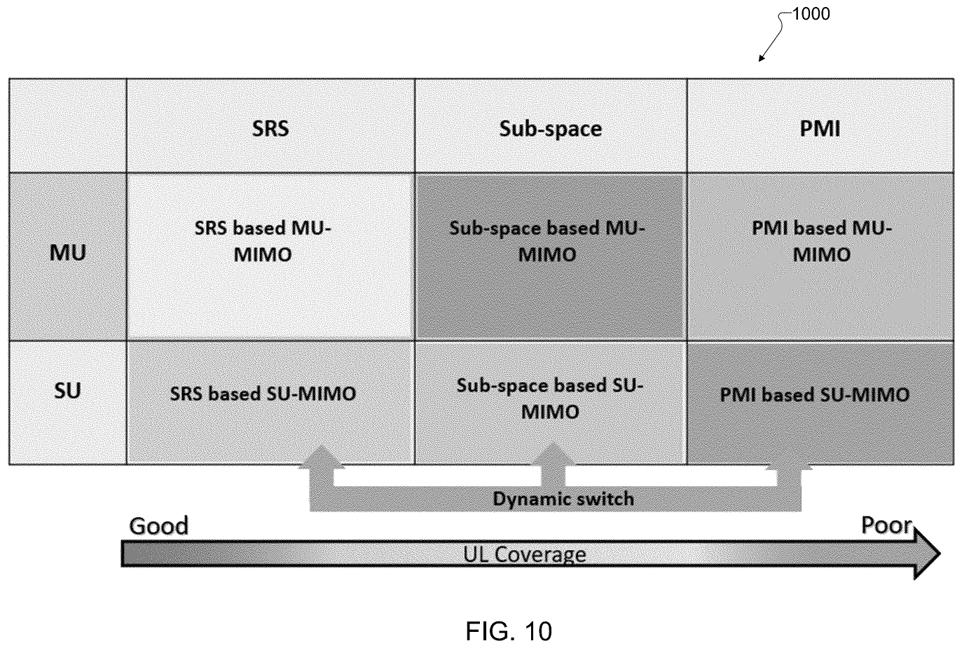

In some embodiments, subspace precoding can be provided as another available option for precoding mode switching as shown in FIG. 10.

FIG. 10 illustrates an example 1000 of precoding mode switching options according to embodiments of the present disclosure. The embodiment of precoding mode switching options of FIG. 1000 is for illustration only. Different embodiments of precoding mode switching options could be used without departing from the scope of this disclosure.

In the example of FIG. 10, six options are available for dynamic precoding mode switching based on UL coverage and MIMO configuration. For example, a BS (such as BS 102 of FIG. 1) may select one of the options based on the UL coverage and the MIMO configuration.

For MU-MIMO and good UL coverage, the BS may select SRS based (i.e., TAS) MU-MIMO precoding. For SU-MIMO and good UL coverage, the BS may select SRS based (i.e., TAS) SU-MIMO precoding.

For MU-MIMO and intermediate UL coverage, the BS may select subspace based MU-MIMO precoding. For SU-MIMO and intermediate UL coverage, the BS may select subspace based SU-MIMO precoding.

For MU-MIMO and poor UL coverage, the BS may select PMI based MU-MIMO precoding. For SU-MIMO and poor UL coverage, the BS may select PMI based SU-MIMO precoding.

Good, intermediate, and poor UL coverage may be determined based on a predetermined SRS SNR. For example, an SRS SNR above a first threshold may be considered good UL coverage, while an SRS NR below a second threshold less than the first threshold may be considered poor UL coverage. SRS NR below the first threshold and above the second threshold may be considered intermediate UL coverage.

Although FIG. 10 illustrates one example 1000 of precoding mode switching options, various changes may be made to FIG. 10. For example, various changes to the number of precoding mode options, the switching conditions, etc. could be made according to particular needs.

In some embodiments, subspace precoding can be used to achieve wideband MU precoding with a mix of SRS and PMI availability.

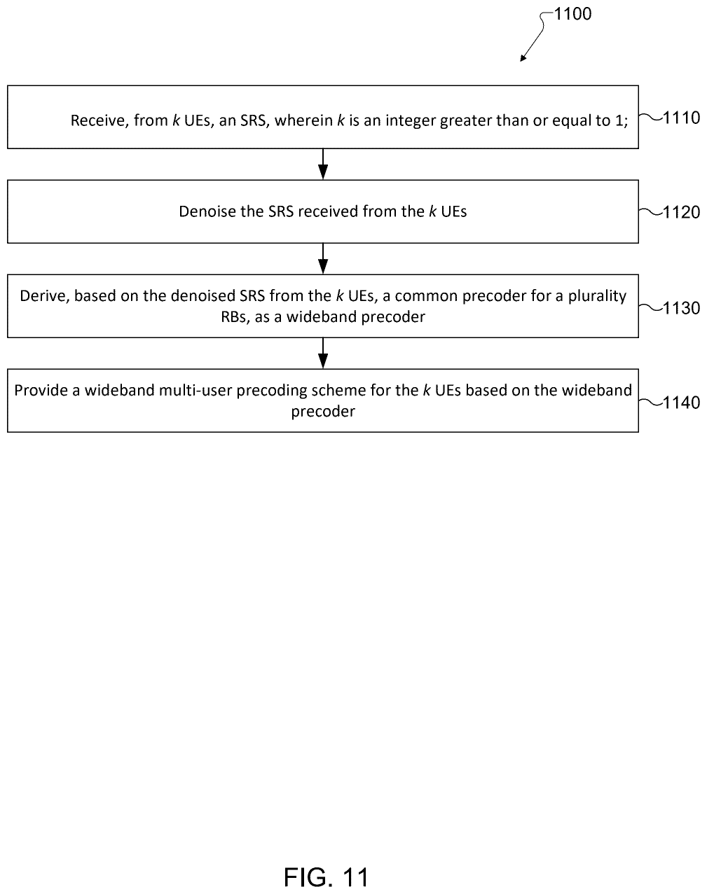

FIG. 11 illustrates an example method 1100 for subspace precoding according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments for subspace precoding could be used without departing from the scope of this disclosure.

In the example of FIG. 11, method 1100 begins at step 1110. At step 1110, a BS (such as BS 102 of FIG. 1) receives, from k UEs (such as UEs 111-116 of FIG. 1), an SRS. k is an integer greater than or equal to 1. For example, in some embodiments, k may be 1, where only a single UE (such as UE 116) UE transmits SRS received by the BS. In other embodiments, k may be greater than 1 (e.g., k may be 6) where multiple UEs (such as UEs 111-116) transmit SRS received by the BS.

At step 1120, the BS denoises the SRS received from the k UEs. In some embodiments, the BS may only denoise SRS corresponding to UEs among the k UEs that have intermediate coverage (e.g., intermediated SRS SNR).

At step 1130, the BS derives, based on the denoised SRS from the k UEs, a common precoder for a plurality of RBs, as a wideband precoder.

In some embodiments, the wideband precoder is a subspace precoder for a MU, rank=1 transmission, and the subspace precoder is derived to maximize an SLNR. For example, the subspace precoder pᵢ^{k} for the MU, rank=1 transmission may be derived for the k-th UE (k ∈{1, 2}) as follows:

$${p}_{i}^{k} = \frac{{\sum }_{j = 1}^{{N}_{RB}} {\vert {\{ {H}_{i}^{k} ( j ) \}}^{H} p \vert}^{2}}{{\sum }_{j = 1}^{{N}_{RB}} {\vert {\{ {H}_{i}^{{k}^{′}} ( j ) \}}^{H} p \vert}^{2} + {σ}^{2}}$$

$$s . t . {p}^{H} p = 1 \\ = {arg max}_{p} \frac{{p}^{H} ( \frac{1}{{N}_{RB}} {\sum }_{j = 1}^{{N}_{RB}} {H}_{i}^{k} ( j ) {\{ {H}_{i}^{k} ( j ) \}}^{H} ) p}{{p}^{H} ( \frac{1}{{N}_{RB}} {\sum }_{j = 1}^{{N}_{RB}} {H}_{i}^{{k}^{′}} ( j ) {\{ {H}_{i}^{{k}^{′}} ( j ) \}}^{H} ) p + {\tilde{σ}}^{2}} = {arg max}_{p} \frac{{p}^{H} {R}_{i}^{k} p}{{p}^{H} ( {R}_{i}^{{k}^{′}} + {\tilde{σ}}^{2} I ) p}$$

$$where {R}_{i}^{k} = \frac{1}{{N}_{RB}} {\sum }_{j = 1}^{{N}_{RB}} {H}_{i}^{k} ( j ) {\{ {H}_{i}^{k} ( j ) \}}^{H} , \\ {R}_{i}^{{k}^{′}} = \frac{1}{{N}_{RB}} {\sum }_{j = 1}^{{N}_{RB}} {H}_{i}^{{k}^{′}} ( j ) {\{ {H}_{i}^{{k}^{′}} ( j ) \}}^{H} and$$

$${\tilde{σ}}^{2} = \frac{1}{{N}_{RB}} {σ}^{2} .$$

In some embodiments, the wideband precoder is a subspace precoder for a MU, rank=1 transmission, and the subspace precoder is derived to minimize a signal leakage. For example, the subspace precoder pᵢ^{k} for the MU, rank=1 transmission may be derived for the k-th UE (k ∈{1, 2}) as follows:

For a desired energy ε_{i,des}^{k} and a leakage energy ε_{i,leak}^{k}, where

$${ɛ}_{i , des}^{k} = {\sum }_{j = 1}^{{N}_{RB}} {\vert {\{ {H}_{i}^{k} ( j ) \}}^{H} p \vert}^{2} = {p}^{H} {R}_{i}^{k} p$$

$${E}_{i , leak}^{k} = {\sum }_{j = 1}^{{N}_{RB}} {\vert {\{ {H}_{i}^{{k}^{′}} ( j ) \}}^{H} p \vert}^{2} = {p}^{H} {R}_{i}^{{k}^{′}} p$$

$$s . t . {p}^{H} p = 1$$

$${p}_{i}^{k} = {arg min }_{p} {p}^{H} {R}_{i}^{{k}^{′}} p$$

$$subject to {p}^{H} {R}_{i}^{k} p = 1 .$$

Assuming Rᵢ^{k} is positive definite, Rᵢ^{k}=T^{H}T.

### Considering

$$ν = Tp , {ν}_{i}^{k} = {arg min}_{v} {( {T}^{- 1} ν )}^{H} {R}_{i}^{{k}^{′}} {T}^{- 1} v = {arg min }_{v} {{ν}^{H} ( {T}^{- 1} )}^{H} {R}_{i}^{{k}^{′}} {T}^{- 1} v$$

$$subject to {ν}^{H} ν = 1$$

$${p}_{i}^{k} = {T}^{- 1} {ν}_{i}^{k} .$$

In some embodiments, the wideband precoder is a subspace precoder for a SU, rank>1 transmission, and the subspace precoder is derived to maximize an SLNR. For example, the subspace precoder P^{k} (N_{Tx}×RI^{k}) for the SU, rank>1 transmission may be derived for the k-th UE as follows:

$$\begin{matrix}{P}^{k} ( {N}_{Tx} \times {RI}^{k} ) = {arg max}_{P} {\sum }_{j = 1}^{{N}_{RB}} \frac{1}{{N}_{RB}} Tr \{ {P}^{H} {H}^{k} ( j ) {( {H}^{k} ( j ) )}^{H} P \} \\ = {arg max}_{P} Tr \{ \frac{1}{{N}_{RB}} {\sum }_{j = 1}^{{N}_{RB}} {P}^{H} {H}^{k} ( j ) {( {H}^{k} ( j ) )}^{H} P \} \\ = {arg max}_{P} Tr \{ {P}^{H} {R}^{k} P \}\end{matrix}$$

$$s . t . {P}^{H} {R}^{k} P = {D}^{k} ( diagonal matrix )$$

$$Tr \{ {P}^{H} P \} = {RI}^{k}$$

$$where , {R}^{k} \frac{1}{{N}_{RB}} {\sum }_{j = 1}^{{N}_{RB}} {H}^{k} ( j ) {( {H}^{k} ( j ) )}^{H} and$$

$${H}^{k} ( j ) ( {N}_{Tx} \times {RI}^{k} )$$

is the channel matrix of j-th

RB, across RI^{k} UE ports of k-th UE.

In some embodiments, the wideband precoder is a subspace precoder for a MU, rank>1 transmission, and the subspace precoder is derived to maximize an SLNR. For example, the subspace precoder P^{k} for the MU, rank>1 transmission may be derived for the k-th UE (k ∈{1, 2}) as follows:

$$\begin{matrix}{P}^{k} ( {N}_{Tx} \times {RI}^{k} ) = {arg max}_{P} \frac{{\sum }_{j = 1}^{{N}_{RB}} \frac{1}{{N}_{RB}} Tr \{ {P}^{H} {H}^{k} ( j ) {( {H}^{k} ( j ) )}^{H} P \}}{{\sum }_{j = 1}^{{N}_{RB}} Tr \{ {P}^{H} {H}^{{k}^{′}} ( j ) {( {H}^{{k}^{′}} ( j ) )}^{H} P \} + \frac{1}{{N}_{RB}} {σ}^{2} {RI}^{k}} \\ {arg max}_{P} \frac{Tr \{ {P}^{H} {R}^{k} P \}}{Tr \{ {P}^{H} ( {R}^{{k}^{′}} + {\tilde{σ}}^{2} I ) P \}}\end{matrix}$$

$$s . t . {P}^{H} {R}^{k} P = {D}^{k} ( diagonal matrix )$$

$$Tr \{ {P}^{H} P \} = {RI}^{k}$$

$$Where , {R}^{k} = \frac{1}{{N}_{RB}} {\sum }_{j = 1}^{{N}_{RB}} {H}^{k} ( j ) {( {H}^{k} ( j ) )}^{H} , \\ {R}_{i}^{{k}^{′}} = \frac{1}{{N}_{RB}} {\sum }_{j = 1}^{{N}_{RB}} {H}_{i}^{{k}^{′}} ( j ) {\{ {H}_{i}^{{k}^{′}} ( j ) \}}^{H} and$$

$${\tilde{σ}}^{2} = \frac{1}{{N}_{RB}} {\tilde{σ}}^{2} {RI}^{k} .$$

Further, H^{k′}(j) (N_{Tx}×RI^{k′}) is the channel matrix of j-th RB across RI^{k′}′ UE ports of k-th UE whereas H^{k}(j) (N_{Tx}×RI^{k}) is the channel matrix of j-th RB across RI^{k} UE ports of k-th UE.

At step 1140, the BS provides a wideband multi-user precoding scheme for the k UEs based on the wideband precoder. In some embodiments, the wideband multi-user precoding scheme may only be provided to UEs among the k UEs that have intermediate coverage.

In some embodiments, the BS performs at least one of single user and multi-user precoding mode switching between a TAS mode, subspace mode, and a PMI mode based on the SRS received from the k UEs. In some embodiments, the BS switches to the subspace mode when the SRS received from the k UEs has an intermediate SNR. In these embodiments, the intermediate SNR may be predefined. For example, an SNR above a first threshold, and below a second threshold that is higher than the first threshold may be an intermediate SNR.

Although FIG. 11 illustrates one example method 1100 for subspace precoding, various changes may be made to FIG. 11. For example, while shown as a series of steps, various steps in FIG. 11 could overlap, occur in parallel, occur in a different order, occur any number of times, be omitted, or replaced by other steps.

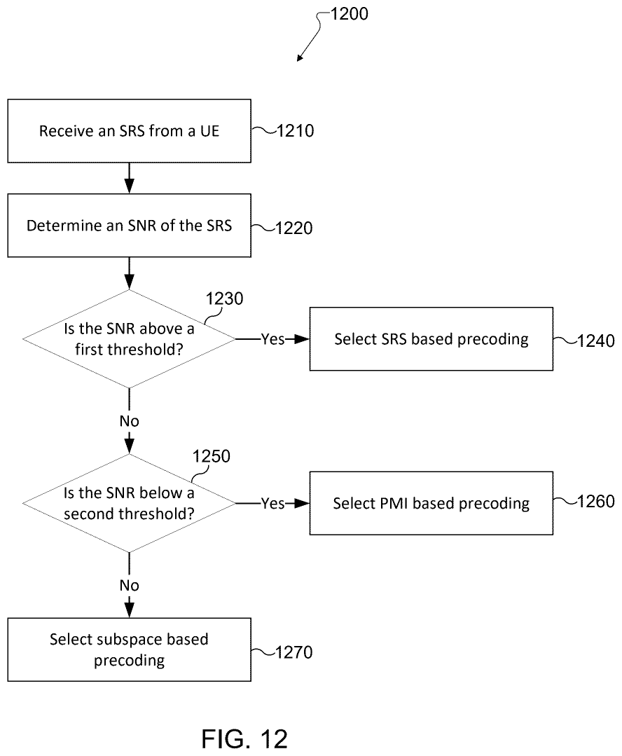

FIG. 12 illustrates an example method 1200 for dynamic precoding mode switching according to embodiments of the present disclosure. An embodiment of the method illustrated in FIG. 12 is for illustration only. One or more of the components illustrated in FIG. 11 may be implemented in specialized circuitry configured to perform the noted functions or one or more of the components may be implemented by one or more processors executing instructions to perform the noted functions. Other embodiments for subspace precoding could be used without departing from the scope of this disclosure.

In the example of FIG. 12, method 1200 begins at step 1210. At step 1210 a BS (such as BS 102 of FIG. 1) receives an SRS from a UE (such as UE 116 of FIG. 1).

At step 1220, the BS determines an SNR of the SRS.

At step 1230, if the SNR is above a first threshold, the BS determines that the UE has good UL coverage, and at step 1240 the BS selects SRS based precoding mode for the UE. Otherwise, if the SNR is not above the first threshold, method 1200 proceeds to step 1250.

At step 1240, if the UE is not already operating in SRS based precoding mode, the BS configures the UE to switch operation to SRS based precoding mode.

At step 1250, the BS determines whether the SNR is below a second threshold. The second threshold is lower than the first threshold. If the SNR is below the second threshold, the BS determines that the UE has good UL coverage, and at step 1260 the BS selects PMI based precoding mode for the UE. Otherwise, if the SNR is not below the second threshold (i.e., the SNR is between the first threshold and the second threshold), the BS determines that the UE has intermediate UL coverage, and selects subspace based precoding mode for the UE.

At step 1260, if the UE is not already operating in PMI based precoding mode, the BS configures the UE to switch operation to PMI based precoding mode.

At step 1270, if the UE is not already operating in subspace based precoding mode, the BS configures the UE to switch operation to subspace based precoding mode.

In some embodiments, the selected precoding mode may be for SU-MIMO. In some embodiments, the selected precoding mode may be for MU-MIMO.

In some embodiments, when subspace based precoding is selected, the BS may select a subspace precoder for the UE similar as described regarding FIGS. 8 and 11. For example, the BS may denoise the SRS denoise the SRS received from k UEs (including the UE), derive, based on the denoised SRS from the k UEs, a common precoder for a plurality of resource blocks (RBs), as a wideband precoder, and provide a wideband multi-user precoding scheme for the k user UEs (including the UE) based on the wideband precoder.

In some embodiments, the wideband precoder may be a subspace precoder for a MU, rank=1 transmission, and the subspace precoder may be derived to maximize an SLNR, similar as described herein.

In some embodiments, the wideband precoder may be a subspace precoder for a MU, rank=1 transmission, and the subspace precoder may be derived to minimize a signal leakage, similar as described herein.

In some embodiments, the wideband precoder may be a subspace precoder for a SU, rank>1 transmission, and the subspace precoder may be derived to maximize an SLNR, similar as described herein.

In some embodiments, the wideband precoder may be a subspace precoder for a MU, rank>1 transmission, and the subspace precoder may be derived to maximize an SLNR, similar as described herein.

Although FIG. 12 illustrates one example method 1200 for dynamic precoding mode switching, various changes may be made to FIG. 12. For example, while shown as a series of steps, various steps in FIG. 12 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A base station (BS) comprising:
a transceiver configured to receive, from k user equipments (UEs), a sounding reference signal (SRS), wherein k is an integer greater than or equal to 1; and
a processor operatively coupled to the transceiver, the processor configured to:
denoise the SRS received from the k UEs;
derive, based on the denoised SRS from the k UEs, a common precoder for a plurality of resource blocks (RBs), as a wideband precoder; and
provide a wideband multi-user precoding scheme for the k user UEs based on the wideband precoder.

2. The BS of claim 1, wherein:
the wideband precoder is a subspace precoder for a multi user, rank=1 transmission; and
the subspace precoder is derived to maximize a signal-to-leakage-and-noise ratio (SLNR).

3. The BS of claim 1, wherein:
the wideband precoder is a subspace precoder for a multi user, rank=1 transmission; and
the subspace precoder is derived to minimize a signal leakage.

4. The BS of claim 1, wherein:
the wideband precoder is a subspace precoder for a single user, rank>1 transmission; and
the subspace precoder is derived to maximize a signal-to-leakage-and-noise ratio (SLNR).

5. The BS of claim 1, wherein:
the wideband precoder is subspace precoder for a multi user, rank>1 transmission; and
the subspace precoder is derived to maximize a signal-to-leakage-and-noise ratio (SLNR).

6. The BS of claim 1, wherein:
the processor is further configured to perform at least one of single user (SU) and multi-user (MU) precoding mode switching between a transmit antenna switching (TAS) mode, subspace mode, and a precoding matrix indicator (PMI) mode based on the SRS received from the k UEs.

7. The BS of claim 6, wherein the processor is further configured to switch to the subspace mode when the SRS received from the k UEs has an intermediate signal-to noise-ratio (SNR).

8. A method of operating a base station (BS), the method comprising:
receiving, from k user equipments (UEs), a sounding reference signal (SRS), wherein k is an integer greater than or equal to 1;
denoising the SRS received from the k UEs;
deriving, based on the denoised SRS from the k UEs, a common precoder for a plurality of resource blocks (RBs), as a wideband precoder; and
providing a wideband multi-user precoding scheme for the k UEs based on the wideband precoder.

9. The method of claim 8, wherein:
the wideband precoder is a subspace precoder for a multi user, rank=1 transmission; and
the subspace precoder is derived to maximize a signal-to-leakage-and-noise ratio (SLNR).

10. The method of claim 8, wherein:
the wideband precoder is a subspace precoder for a multi user, rank=1 transmission; and
the subspace precoder is derived to minimize a signal leakage.

11. The method of claim 8, wherein:
the wideband precoder is a subspace precoder for a single user, rank>1 transmission; and
the subspace precoder is derived to maximize a signal-to-leakage-and-noise ratio (SLNR).

12. The method of claim 8, wherein:
the wideband precoder is subspace precoder for a multi user, rank>1 transmission; and
the subspace precoder is derived to maximize a signal-to-leakage-and-noise ratio (SLNR).

13. The method of claim 8, further comprising performing at least one of single user (SU) and multi-user (MU) precoding mode switching between a transmit antenna switching (TAS) mode, subspace mode, and a precoding matrix indicator (PMI) mode based on the SRS received from the k UEs.

14. The method of claim 13, further comprising switching to the subspace mode when the SRS received from the k UEs has an intermediate signal-to-noise ratio (SNR).

15. A non-transitory computer readable medium embodying a computer program comprising program code that, when executed by a processor of a device, causes the device to:
receive, from k user equipments (UEs), a sounding reference signal (SRS), wherein k is an integer greater than or equal to 1;
denoise the SRS received from the k UEs;
derive, based on the denoised SRS from the k UEs, a common precoder for a plurality of resource blocks (RBs), as a wideband precoder; and
provide a wideband multi-user precoding scheme for the k UEs based on the wideband precoder.

16. The non-transitory computer readable medium of claim 15, wherein:
the wideband precoder is a subspace precoder for a multi user, rank=1 transmission; and
the subspace precoder is derived to maximize a signal-to-leakage-and-noise ratio (SLNR).

17. The non-transitory computer readable medium of claim 15, wherein:
the wideband precoder is a subspace precoder for a multi user, rank=1 transmission; and
the subspace precoder is derived to minimize a signal leakage.

18. The non-transitory computer readable medium of claim 15, wherein:
the wideband precoder is a subspace precoder for a single user, rank>1 transmission; and
the subspace precoder is derived to maximize a signal-to-leakage-and-noise ratio (SLNR).

19. The non-transitory computer readable medium of claim 15, wherein:
the wideband precoder is subspace precoder for a multi user, rank>1 transmission; and
the subspace precoder is derived to maximize a signal-to-leakage-and-noise ratio (SLNR).

20. The non-transitory computer readable medium of claim 15, wherein the computer program further comprises program code that, when executed by the processor, causes the device to perform at least one of single user (SU) and multi-user (MU) precoding mode switching between a transmit antenna switching (TAS) mode, subspace mode, and a precoding matrix indicator (PMI) mode based on the SRS received from the k UEs, wherein the switching to the subspace mode is performed when the SRS received from the k UEs has an intermediate signal-to-noise ratio (SNR).
